(19) United States
(12) Patent Application Publication
(10) Pub. No.: US 2019/0041290 A1
(43) Pub. Date: Feb. 7, 2019

(54) METHOD AND DEVICE FOR DETECTING THE AZIMUTHAL ANGULAR POSITION OF A WHEEL IMBALANCE OF A WHEEL ON A VEHICLE

(71) Applicant: Robert Bosch GmbH, Stuttgart (DE)

(72) Inventors: Marcus Wagner, Schwaigern (DE); Jan Scheuing, Brackenheim (DE); Vishwanath Malipatil, Heilbronn (DE)

(73) Assignee: Robert Bosch GmbH, Stuttgart (DE)

(21) Appl. No.: 16/066,891

(22) PCT Filed: Nov. 30, 2016
(86) PCT No.: PCT/EP2016/079352

§ 371 Date: Jun. 28, 2018

(30) Foreign Application Priority Data
Jan. 29, 2016 (DE) 10 2016 201 331.9

(51) Int. Cl. G01M 1/28

(52) U.S. Cl. CPC G01M 1/28

(57) ABSTRACT

A method for the detection of the azimuthal angular position of a wheel imbalance in a wheel of a vehicle, in which the presence of a wheel imbalance is detected on the basis of the output signals of a wheel rotational speed sensor assigned to the wheel, at least one driving dynamics quantity describing the instantaneous driving situation is ascertained, and the azimuthal angular position of the wheel imbalance is ascertained as a function of the driving dynamics quantity.

### BACKGROUND INFORMATION

German Patent Application No. DE 197 35 313 A1 describes a method for ascertaining speed-independent frequencies of a useful signal portion.

This method makes use of the systematic recurrence of errors in the speed signal acquired by rotational speed signals in order to acquire, for example, an imbalance.

### SUMMARY

The present invention relates to a method for ascertaining an imbalance angular quantity that describes the azimuthal angular position of a wheel imbalance of a wheel of a vehicle, in which
the presence of a wheel imbalance is detected on the basis of the output signals of a wheel rotational speed sensor assigned to the wheel,
at least one driving dynamics quantity describing the instantaneous driving situation is ascertained,
a first angular quantity, describing the azimuthal angle between the wheel imbalance and the wheel rotational speed sensor, is ascertained as a function of the driving dynamics quantity,
a second angular quantity, describing the azimuthal angle between the wheel rotational speed sensor and a reference point on the wheel, is ascertained, and
an imbalance angular quantity, describing the azimuthal angle between the wheel imbalance and the reference point on the wheel, is ascertained as a function of the first angular quantity and the second angular quantity.

Numerous driving dynamics quantities are standardly ascertained already in the control devices of modern vehicles, and wheel rotational speed sensors are already part of the standard equipment of modern vehicles. The first angular quantity is the azimuthal angle between the imbalance in the wheel plane relative to the rotational speed sensor, or wheel rotational speed sensor. This azimuthal angle can be understood in such a way that a wheel imbalance is expressed in phase-shifted fashion in the output signal of the rotational speed sensor. That is, at the time of acquisition of the wheel imbalance via the rotational speed sensor signal, the wheel has already further rotated by a certain angle, namely the first angular quantity. From the knowledge of the first and second angular quantity, i.e., on the basis of the angle between the imbalance wheel rotational speed sensor and the wheel rotational speed sensor reference point, the angle between the wheel imbalance and the reference point can easily be ascertained. On the basis of this angle, the position of the imbalance can easily be determined in a workshop.

For example, the angular position zero can be assigned to the wheel valve, and the imbalance angular quantity is then related to the wheel valve. An angle of 360° leads back to the wheel valve.

An advantageous example embodiment of the present invention includes the first angular quantity being ascertained from the at least one driving dynamics quantity using a database that is stored in the vehicle or is wirelessly accessible.

An advantageous embodiment of the present invention includes the driving dynamics quantity being the vehicle longitudinal speed.

An advantageous embodiment of the present invention is characterized in that the reference point is the wheel valve. This point can be located particularly easily, and does not require any separate marking or identification.

An advantageous example embodiment of the present invention includes the database being created on the basis of defined driving maneuvers that are executed by the vehicle of the relevant type in an application phase or calibration phase, a defined wheel imbalance being attached to at least one wheel of the vehicle, at a position that is defined with regard to the azimuthal angle between the wheel imbalance and the reference point.

An advantageous example embodiment of the present invention includes that the defined driving maneuvers include driving intervals having constant speed, the constant speed being different in the different driving intervals.

An advantageous example embodiment of the present invention is characterized in that a wheel imbalance is detected as present when the output signal of the wheel rotational speed sensor has a disturbance that recurs with each wheel rotation.

An advantageous example embodiment of the present invention is characterized in that the disturbance is a brief signal peak.

In addition, the present invention includes a device that contains equipment designed to carry out the method according to the present invention. This is in particular a control device in which the program code for carrying out the method according to the present invention is stored.

### BRIEF DESCRIPTION OF THE DRAWING

FIG. 1 shows the sequence of a specific embodiment of the method according to the present invention.

### DETAILED DESCRIPTION OF EXAMPLE EMBODIMENTS

Wheel imbalances can be recognized in the output signal of a wheel rotational speed sensor on the basis of a disturbance of the wheel speed that recurs periodically with each wheel rotation. In accordance with the present invention, the azimuthal position of the wheel imbalance, e.g. the azimuthal angle relative to the wheel valve, is ascertained on the basis of the wheel rotational speed signal. In this context, the periodic disturbance in the wheel rotational speed signal is first recognizable in phase-shifted fashion. That is, at the time at which the rotational speed sensor acquires the signal disturbance, the imbalance has already passed the rotational speed sensor. In addition, this phase shift has a strong functional dependence on the particular vehicle type, and on the vehicle speed at that instant. Therefore, in the application phase the wheels of the relevant vehicle type are provided with a defined imbalance weight attached at a defined position. The application or calibration should be carried out for all wheels of the vehicle, but at least for one wheel per axle.

The vehicle having wheels prepared in this way carries out defined driving maneuvers that in particular also include segments having a defined vehicle speed. Due to the deliberate preparation of the wheels with the imbalance attached at a defined position, the current azimuthal position of the imbalance is known at all times. Therefore, it is also known at which azimuthal position the imbalance is actually situated when this imbalance is expressed as a signal disturbance in the rotational speed sensor signal. From this knowledge, the phase shift can be ascertained.

The carrying out and evaluation of these defined driving maneuvers permits the creation of a database that includes the phase shifts associated with specified speed values. Here it is again to be emphasized that the entries in this database are not relations that hold for any type of vehicle, but rather are different for each vehicle model or vehicle type. This results in particular due to the different suspension and damping characteristics of different vehicle types.

If, during later, real driving operation with non-prepared wheels, an imbalance is determined on the basis of a rotational speed sensor signal, then on the basis of the current vehicle speed the associated phase shift can be ascertained from the database, and thus the azimuthal position of the imbalance can also be ascertained. This position can for example be communicated directly to a workshop wirelessly, or can be stored in an error memory of the control device, so that a later balancing of the wheel can be carried out more easily and more precisely.

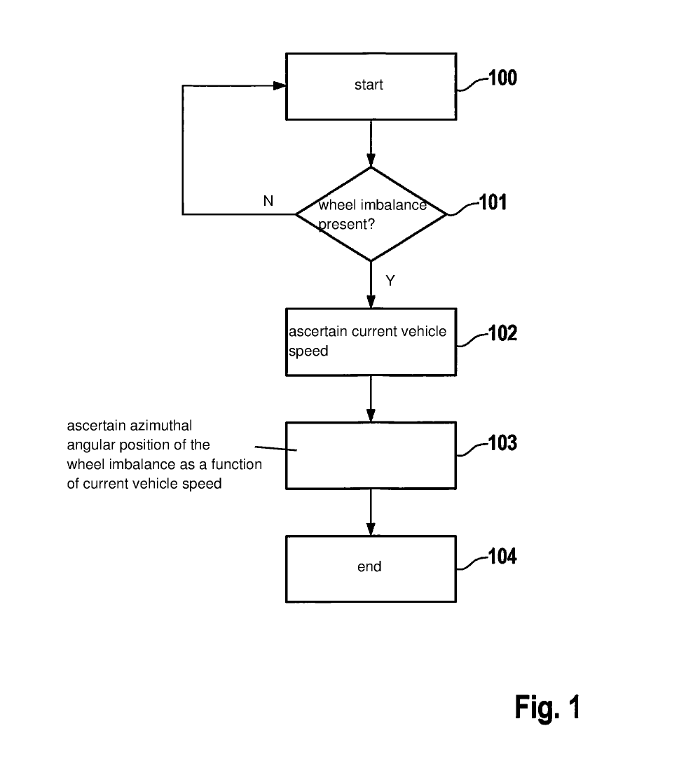

FIG. 1 shows the sequence of an embodiment of the method according to the present invention. After the start of the method in block 100, in block 101 it is checked whether a wheel imbalance is present. If this is not the case, then the method returns to block 100. However, if a wheel imbalance is present, then in block 102 the current vehicle speed is ascertained, or is read from a memory device, and in block 103 the azimuthal angular position of the wheel imbalance is subsequently ascertained as a function of the current vehicle speed. The method ends in block 104.

1-9. (canceled)

10. A method for ascertaining an imbalance angular quantity that describes an azimuthal angular position of a wheel imbalance of a wheel of a vehicle, comprising:
detecting a presence of a wheel imbalance based on output signals of a wheel rotational speed sensor assigned to the wheel;
ascertaining at least one driving dynamics quantity that describes an instantaneous driving situation;
ascertaining, as a function of the driving dynamics quantity, a first angular quantity that describes an azimuthal angle between the wheel imbalance and the wheel rotational speed sensor;
ascertaining a second angular quantity hat describes an azimuthal angle between the wheel rotational speed sensor and a reference point on the wheel; and
ascertaining, as a function of the first angular quantity and the second angular quantity, an imbalance angular quantity that describes the azimuthal angle between the wheel imbalance and the reference point on the wheel.

11. The method as recited in claim 10, wherein the first angular quantity is ascertained from the at least one driving dynamics quantity using a database that is one of: (i) stored in the vehicle, or (ii) is wirelessly accessible.

12. The method as recited in claim 10, wherein the driving dynamics quantity is the vehicle longitudinal speed.

13. The method as recited in claim 10, wherein the reference point is a wheel valve.

14. The method as recited in claim 11, wherein the database is created on the basis of defined driving maneuvers that are carried out by a vehicle of the relevant type in an application phase, a defined wheel imbalance being attached to at least one wheel of the vehicle at a position that is defined with regard to the azimuthal angle between the wheel imbalance and the reference point.

15. The method as recited in claim 14, wherein the defined driving maneuvers include driving intervals having a constant value of the driving dynamics quantity during the driving interval, the constant value being different in the different driving intervals.

16. The method as recited in claim 10, wherein a wheel imbalance is detected as present when the output signal of the wheel rotational speed sensor has a disturbance that recurs with each wheel rotation.

17. The method as recited in claim 16, wherein the disturbance is a brief signal peak.

18. A device containing equipment for ascertaining an imbalance angular quantity that describes an azimuthal angular position of a wheel imbalance of a wheel of a vehicle, the device configured to:
detect a presence of a wheel imbalance based on output signals of a wheel rotational speed sensor assigned to the wheel;
ascertain at least one driving dynamics quantity that describes an instantaneous driving situation;
ascertain, as a function of the driving dynamics quantity, a first angular quantity that describes an azimuthal angle between the wheel imbalance and the wheel rotational speed sensor;
ascertain a second angular quantity hat describes an azimuthal angle between the wheel rotational speed sensor and a reference point on the wheel; and
ascertain, as a function of the first angular quantity and the second angular quantity, an imbalance angular quantity that describes the azimuthal angle between the wheel imbalance and the reference point on the wheel.
